(19) United States
(12) Patent Application Publication
(10) Pub. No.: US 2013/0057071 A1
(43) Pub. Date: Mar. 7, 2013

(54) FUEL CELL BATTERY CHARGE/DISCHARGE MANAGEMENT SYSTEM AND METHOD

(71) Applicants: Stephen M. Babula, Carrollton, TX (US); James A. Pruett, Allen, TX (US); Howard C. Choe, Southlake, TX (US)

(72) Inventors: Stephen M. Babula, Carrollton, TX (US); James A. Pruett, Allen, TX (US); Howard C. Choe, Southlake, TX (US)

(73) Assignee: Raytheon Company, Waltham, MA (US)

(21) Appl. No.: 13/295,342

(22) Filed: Nov. 14, 2011

Related U.S. Application Data
(60) Provisional application No. 61/531,558, filed on Sep. 6, 2011.

(51) Int. Cl. H02J 7/34

(52) U.S. Cl. 307/48

(57) ABSTRACT

According to an embodiment of the disclosure, a system for supplying power to a device includes a battery, a mobile recharging power supply, a battery output, and a controller. The battery output is configured to supply power to the device. The controller is configured to upon detecting that a current through the battery output is below a threshold, initiate a supply of power to the battery output from the mobile recharging power supply. Additionally, the controller is configured to upon detecting that the current through the battery output is above the threshold, initiate a supply of power to the battery output from the battery.

### RELATED APPLICATIONS

This application claims the benefit of U.S. Provisional Application Ser. No. 61/531,558 filed Sep. 6, 2011, which is incorporated by reference herein.

### TECHNICAL FIELD

The present disclosure is directed in general to batteries and more specifically to a fuel cell battery charge/discharge management system and method.

### BACKGROUND OF THE DISCLOSURE

A variety of rechargeable batteries are known. A difficulty with such rechargeable batteries may arise when there is no power source available to recharge the batteries.

### SUMMARY OF THE DISCLOSURE

To address one or more of the above-identified deficiencies of the prior art, one embodiment of the disclosure is a system for supplying power to a device that includes a battery, a mobile recharging power supply, a battery output, and a controller. The battery output is configured to supply power to the device. The controller is configured to upon detecting that a current through the battery output is below a threshold, initiate a supply of power to the battery output from the mobile recharging power supply. Additionally, the controller is configured to upon detecting that the current through the battery output is above the threshold, initiate a supply of power to the battery output from the battery.

Certain embodiments of the disclosure may provide various technical advantages depending on the implementation. For example, a technical advantage may include the ability to use a mobile fuel cell to recharge a battery to thereby extend the duration of use of the battery/power source. Another technical advantage may include the ability to extend the usage time of a battery. Yet another technical advantage may include the ability to allow charging of a battery while mobile. Still other technical advantage may include the ability to allow a fuel cell to extend the duration for mobile use of electronic equipment. Still yet another technical advantage may include the ability to switch between a fuel cell and a battery as a power source dependent on a current load.

Although specific advantages have been enumerated above, various embodiments may include some, none, or all of the enumerated advantages. Additionally, other technical advantages may become readily apparent to one of ordinary skill in the art after review of the following figures and description.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a power flow diagram of a system according to an embodiment of the disclosure;

FIG. 2 illustrates another power flow diagram of a system according to an embodiment of the disclosure;

FIG. 3 illustrates a process according to an embodiment of the disclosure; and

FIG. 4 illustrates a general purpose computer that may be used in connection with other embodiments of the disclosure to carry out any referenced functions.

### DETAILED DESCRIPTION

It should be understood at the outset that, although example embodiments are illustrated below, the present invention may be implemented using any number of techniques, whether currently known or not. The present invention should in no way be limited to the example implementations, drawings, and techniques illustrated below. Additionally, the drawings are not necessarily drawn to scale.

In mobile and other electronic equipment, a power source often needs to supply power for as long as possible. To extend the usage time of the power source, a rechargeable battery may be used. However, problems may be encountered in mobile settings where power sources are not readily available to recharge a battery.

Given such concerns, certain embodiments of the disclosure teach a system and method to extend the duration of a battery that supplies power to electronic equipment by charging the battery with a mobile fuel cell source. Additionally, in particular embodiments, if the electronic load for the electronic equipment using the battery is light, the mobile fuel cell source may power the electronic equipment while also recharging the battery. Certain embodiments of the disclosure also teach a switching from the mobile fuel cell source as the power supply to the battery as the power supply when a determination is made that an electric load switches from light to heavy.

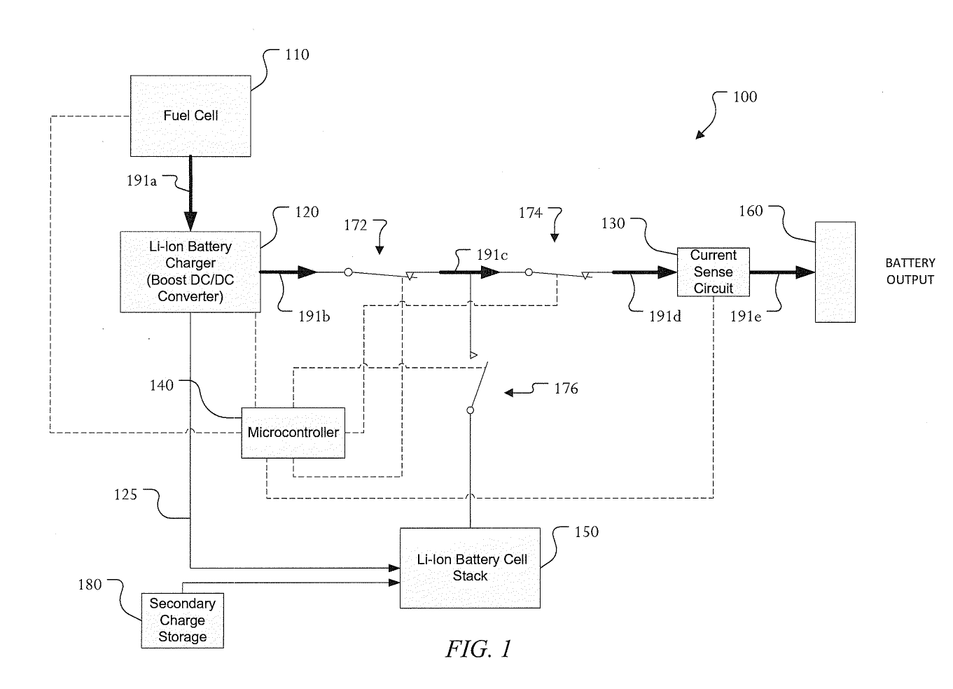

FIG. 1 illustrates a power flow diagram of a system 100 according to an embodiment of the disclosure. The system 100 of FIG. 1 corresponds to a scenario where the electric load is considered light. Although certain details will be provided with reference to the components of the system 100 of FIG. 1, it should be understood that other embodiments may include more, less, or different components. The system 100 of FIG. 1 includes a recharging power supply 110; a battery charger 120; a current sensing circuit 130; a microcontroller 140; a battery 150; a battery output 160; a plurality of switches 172, 174, and 176; and a secondary charge storage 180.

The recharging power supply 110 represents any suitable source of power for recharging a battery and, in this embodiment, is shown as a fuel cell. Fuel cells convert chemical energy from a fuel into electrical energy via a chemical reaction with oxygen or some other oxidizing agent(s). Hydrogen is a common fuel used in fuel cells; however, other fuels may be utilized including butane, natural gas and methanol. When fuel in the fuel cell is exhausted, cartridges in the fuel cell may be replaced in a manner that is apparent to one of ordinary skill in the art, so further details of fuel cells are not provided. In particular embodiments, the recharging power supply 110 may not be particularly well-suited to serve as a power supply when a high current (relative to the recharging power supply) is needed for a device.

The battery charger 120 is any suitable device that can take energy from the recharging power supply 110 for use in supplying power to the battery output 160, supplying recharge power to the battery 150, or supplying energy to the secondary charge storage 180 as discussed in further detail below. In the embodiment of FIG. 1, the battery charger 120 is shown with a boost DC/DC converter, meaning that an output direct current (DC) voltage may be larger than an input DC voltage.

The current sensing circuit 130 may be any suitable device for sensing current through the battery output 160.

The microcontroller 140 controls various operations in the system 100, such as the operation of the switches 172-176. In particular embodiments, the microcontroller 140 may include a processor, memory, and peripheral modules that allow the microcontroller 140 to communicate with other devices. The microcontroller 140 may be capable of processing a variety of logic either stored therein or stored on another device. The dashed lines in FIG. 1 between the microcontroller 140 and various components represent communication—either with appropriate wiring or wirelessly—between the microcontroller 140 and such components.

In some embodiments, the microcontroller 140 obtains information concerning current through the battery output 160 from the current sensing circuit 130. Based on the value of the current, the microcontroller 140 can perform a variety of actions. For example, the microcontroller 140 may send appropriate signals to open and/or close switches 172, 174, and 176. The microcontroller 140 may also send signal(s) to one or both of the recharging power supply 110 and the battery charger 120. Note that the value of the current upon which the microcontroller 140 acts may vary. In some embodiments, for example, the value may depend on the particular recharging power supply 110 being utilized. Although a microcontroller 140 is shown in this embodiment, other embodiments may use other types of control devices, such as processors, memory, and peripherals not technically forming a microcontroller.

The battery 150 may be any of a variety of rechargeable batteries, including, but not limited to, lead-acid, alkaline, nickel-iron, nickel-cadmium, lithium ion, and lithium sulfur batteries. In the embodiment of FIG. 1, the battery 150 is shown as a lithium ion battery. The battery output 160 represents any suitable connection for any suitable device requiring power. The secondary charge storage 180 may be any suitable device that can store a charge, such as a capacitor or another battery (similar or different than the battery 150).

In one aspect of operation, the microcontroller 140 can sense a light current or light load at the battery output 160. As indicated above, the value of what can be considered “light” may depend on various factors, such as the particular recharging power supply 110 being used. As referenced above, in particular embodiments, the recharging power supply 110 may not be considered adept at serving as the power supply for particular currents.

When a sensed current is low, the microcontroller 140 sends signals to close switches 172, 174 and open switch 176. By closing switches 172 and 174, the power for the battery output 160 is provided by the recharging power supply 110 as indicated by arrows 191a-191e. The opening of switch 176 disallows the battery 150 from providing power to the battery output 160. The microcontroller 140 also sends appropriate signals to the recharging power supply 110 and the battery charger 120 to indicate that charging of the battery 150 is to occur as indicated by arrow 125. The charger 120 may be connected to the battery 150 in any suitable manner. In addition to receiving recharge energy from the battery charger 120, the battery 150 may also receive a charge from the secondary charge storage 180.

In other embodiments, no current may be required at the battery output 160 when the battery 150 is being recharged. In such embodiments, one of the switches 172 or 174 could be opened, and the recharging power supply 110 could simply provide energy to the battery 150.

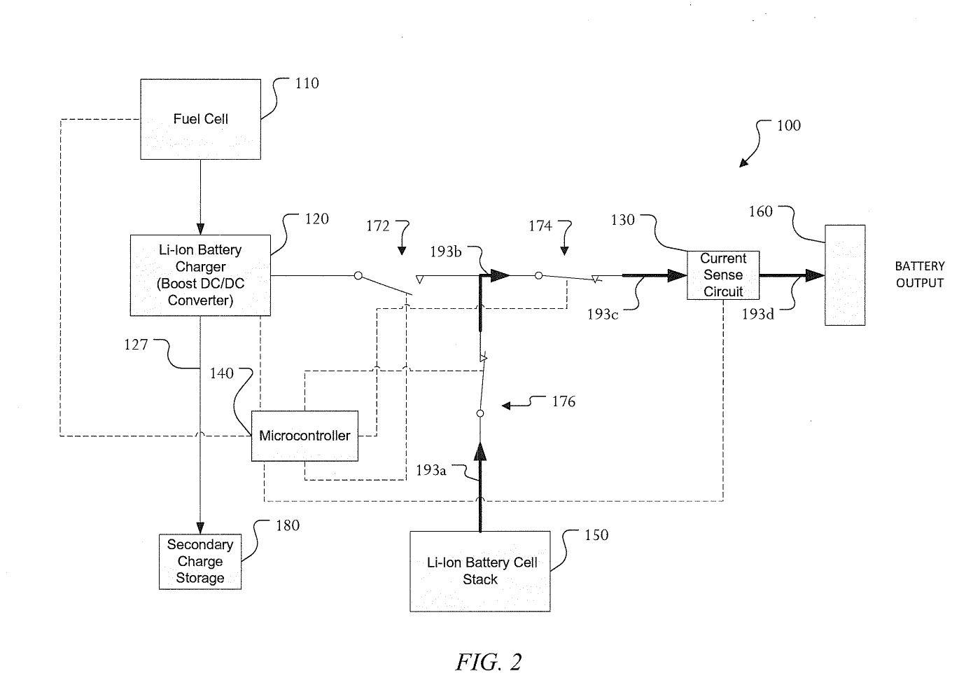

FIG. 2 illustrates another power flow diagram of a system 200 according to an embodiment of the disclosure. The system 200 of FIG. 2 corresponds to a scenario where the electric load is considered heavy. The system 200 of FIG. 2 includes the same components mentioned with reference to FIG. 1, including the recharging power supply 110; the battery charger 120; the current sensing circuit 130; the microcontroller 140; the battery 150; the battery output 160; the switches 172, 174, and 176; and the secondary charge storage 180.

In one aspect of operation, the microcontroller 140 can sense via current sense circuit 130 that the load for the battery output 160 is heavy. In this case, the microcontroller 140 sends signals to close switches 174, 176 and open switch 172.

By closing switches 174 and 176, the power for the battery output 160 is provided by the battery 150 as indicated by arrows 193a-193d. The opening of switch 172 disallows the recharging power supply 110 from providing power to the battery output 160. The microcontroller 140 also sends appropriate signals to the recharging power supply 110 and/or battery charger 120 to indicate that charging of the secondary charge storage 180 is to occur through the charger 120 as indicated by arrow 127. The charger 120 may be connected to the secondary charge storage 180 in any suitable manner. Such a charging of the secondary charge storage 180 may preserve energy because, in certain embodiments, the recharging power supply 110 may require continuous transfer of energy.

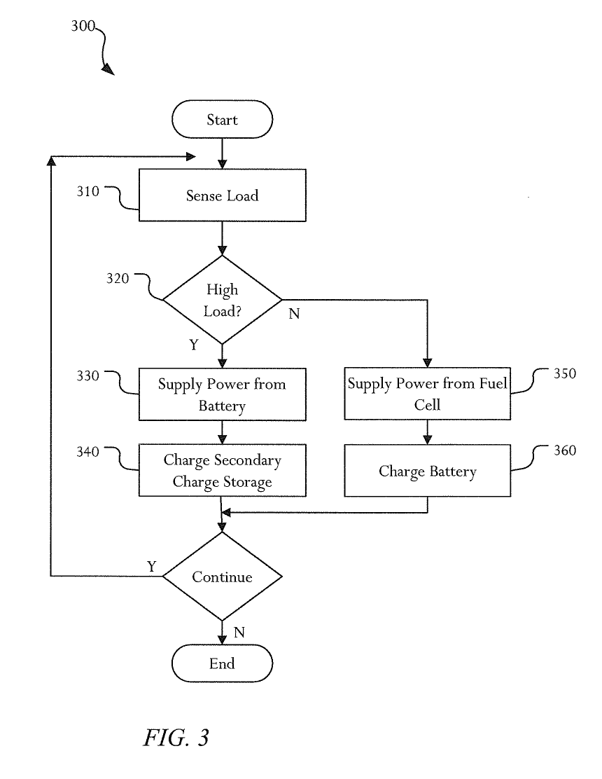

FIG. 3 illustrates a process 300 according to an embodiment of the disclosure. This process 300 may be utilized with components described in FIGS. 1 and 2 or with other components. At step 310, the load of a device requiring power may be sensed. In particular embodiments, the current of the load may be sensed.

At step 320, a determination is made as to whether or not the load is high. As referenced above, the threshold value for whether or not a load is considered high may be dependent on various factors, such as the particular recharging power supply 110 in certain embodiments.

If the load is considered high, the power for the device is supplied by the battery at step 330 and the secondary charge storage is charged at step 340. If the load is not considered high, the power for the device is supplied by the recharging power supply 110 (e.g., fuel cell) at step 350 and the battery is charged at step 360.

After both steps 340 and 360, the process 300 may determine whether or not it should continue at decisional step 370. If so, the process 300 returns to step 310. If not, the process 300 may end. By repeating the process 300, a continuous switching may occur between the recharging power supply 110 providing the power to the device and the battery providing the power to the device. This switching is dependent in particular embodiments on the current provided to the device.

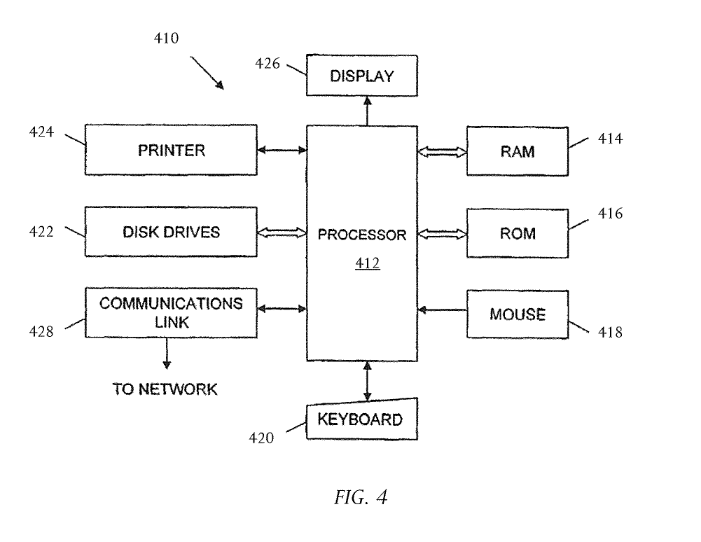

FIG. 4 illustrates a general purpose computer 410 that may be used in connection with other embodiments of the disclosure to carry out or work in conjunction with any of the above-referenced functions. General purpose computer 410 may generally be adapted to execute any of the known OS2, UNIX, MAC-OS, LINUX, ANDROID and/or WINDOWS Operating Systems or other operating systems. The general purpose computer 410 in this embodiment includes a processor 412, a random access memory (RAM) 414, a read only memory (ROM) 416, a mouse 418, a keyboard 420 and input/output devices such as a printer 424, disk drives 422, a display 426 and a communications link 428. In other embodiments, the general purpose computer 410 may include more, less, or other component parts. Embodiments of the present disclosure may include programs that may be stored in the RAM 414, the ROM 416 the disk drives 422, or other storage medium and may be executed by the processor 412 in order to carry out functions described herein. The communications link 428 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding. Disk drives 422 may include a variety of types of storage media such as, for example, floppy disk drives, hard disk drives, CD ROM drives, DVD ROM drives, magnetic tape drives or other suitable storage media. Although this embodiment employs a plurality of disk drives 422, a single disk drive 422 may be used without departing from the scope of the disclosure.

Although FIG. 4 provides one embodiment of a computer that may be utilized with other embodiments of the disclosure, such other embodiments may additionally utilize computers other than general purpose computers as well as general purpose computers without conventional operating systems. Additionally, embodiments of the disclosure may also employ multiple general purpose computers 410 or other computers networked together in a computer network. Most commonly, multiple general purpose computers 410 or other computers may be networked through the Internet and/or in a client server network. Embodiments of the disclosure may also be used with a combination of separate computer networks each linked together by a private or a public network.

Several embodiments of the disclosure may include logic contained within a medium. In the embodiment of FIG. 4, the logic includes computer software executable on the general purpose computer 410. The medium may include the RAM 414, the ROM 416, the disk drives 422, or other mediums. In other embodiments, the logic may be contained within hardware configuration or a combination of software and hardware configurations. The logic may also be embedded within any other suitable medium without departing from the scope of the disclosure.

It will be understood that well known processes have not been described in detail and have been omitted for brevity. Although specific steps, structures and materials may have been described, the present disclosure may not be limited to these specifics, and others may be substituted as it is well understood by those skilled in the art, and various steps may not necessarily be performed in the sequences shown.

Modifications, additions, or omissions may be made to the systems, apparatuses, and methods described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. As used in this document, “each” refers to each member of a set or each member of a subset of a set.

To aid the Patent Office, and any readers of any patent issued on this application in interpreting the claims appended hereto, applicants wish to note that they do not intend any of the appended claims or claim elements to invoke paragraph 6 of 35 U.S.C. Section 112 as it exists on the date of filing hereof unless the words “means for” or “step for” are explicitly used in the particular claim.

What is claimed is:

1. A system for supplying power to a device, the system comprising:
a battery;
a mobile recharging power supply;
a battery output configured to supply power to the device; and
a controller configured to:
upon detecting that a current through the battery output is below a threshold, initiate a supply of power to the battery output from the mobile recharging power supply, and
upon detecting that the current through the battery output is above the threshold, initiate a supply of power to the battery output from the battery.

2. The system of claim 1, wherein the mobile recharging power supply is configured to charge the battery at least when the current through the battery output is below the threshold.

3. The system of claim 1, wherein the controller is configured to initiate a supply of power to the battery output from either the battery or the mobile recharging power supply by sending a signal to close or open at least one switch.

4. The system of claim 1, wherein the mobile recharging power supply is a fuel cell.

5. The system of claim 1, further comprising:
a secondary charge storage device in communication with the mobile recharging power supply and the battery, wherein the mobile recharging power supply charges the secondary storage device at least when the current through the battery output is above the threshold.

6. The system of claim 5, wherein the secondary charge storage device charges the battery at least when the current through the battery output is below the threshold.

7. A system for supplying power to a device, the system comprising:
a battery;
a mobile recharging power supply;
a battery output configured to supply power to the device; and
a controller configured to:
upon detecting that a current through the battery output is below a threshold, initiate a charging of the battery by the mobile recharging power supply; and
upon detecting that the current through the battery output is above the threshold, initiate a supply of power to the battery output from the battery.

8. The system of claim 7, wherein the controller is configured to initiate a supply of power to the battery output from either the battery by sending a signal to close or open at least one switch.

9. The system of claim 7, wherein the mobile recharging power supply is a fuel cell.

10. The system of claim 7, further comprising:
a secondary charge storage device in communication with the mobile recharging power supply and the battery, wherein the mobile recharging power supply charges the secondary storage device at least when the current through the battery output is above the threshold.

11. The system of claim 10, wherein the secondary charge storage device charges the battery at least when the current through the battery output is below the threshold.

12. A method of supplying power to a device, the method comprising:
detecting whether a current for the device is above or below a threshold;
if the current for the device is above the threshold, supplying power for the device from a battery; and
if the current for the device is below the threshold, supplying power for the device from a mobile charging power supply.

13. The method of claim 12, further comprising:
charging the battery, with the mobile charging power supply, when the current for the device is below the threshold.

14. The method of claim 12, further comprising:
charging a secondary storage, with the mobile charging power supply, when the current for the device is above the threshold.

15. The method of claim 14, further comprising:
charging the battery, with the secondary storage, when the current for the device is below the threshold.

16. The method of claim 12, further comprising:
switching the supplying of the power from the battery to the supplying of the power from the mobile charging power supply when current for the device is above the threshold and decreases below the threshold; and
switching the supplying of the power from the mobile charging power supply to the supplying of the power from the battery when current for the device is below the threshold and increases above the threshold.

17. The method of claim 12, wherein the mobile recharging power supply is a fuel cell.
